(19) United States
(12) Patent Application Publication
(10) Pub. No.: US 2015/0096775 A1
(43) Pub. Date: Apr. 9, 2015

(54) HYDRAULIC PULSE TOOL HAVING A SHUTOFF FUNCTION AND SHUTOFF CONTROL METHOD USED IN SAME

(71) Applicant: TRANMAX MACHINERY CO., LTD., Taichung City (TW)

(72) Inventor: HSIN-CHI CHEN, TAICHUNG CITY (TW)

(73) Assignee: TRANMAX MACHINERY CO., LTD., Taichung City (TW)

(21) Appl. No.: 14/103,226

(22) Filed: Dec. 11, 2013

(30) Foreign Application Priority Data
Oct. 4, 2013 (TW) 102136117

(51) Int. Cl. B25B 23/145; B25B 21/02

(52) U.S. Cl. CPC B25B 23/1453; B25B 21/02
USPC 173/1; 173/200; 173/2

(57) ABSTRACT

A hydraulic pulse tool includes a power supply unit, a drive unit electrically connected to the power supply unit, a hydraulic pulse torque generating unit coupled to the drive unit and rotatable by the drive unit to produce impacts for causing the drive to produce an electric current change, and a control unit for judging the electric current change and controlling the operation of the drive unit subject to the judgment result. Subject to the above-stated technical characteristics, the hydraulic pulse tool, in addition to the shutoff function, can reduce errors in judgment and achieve multi-stage torque output control.

### BACKGROUND OF THE INVENTION

1. Field of the Invention

The present invention relates to electric tool technology, and more particularly to a hydraulic pulse tool having a shutoff function.

2. Description of the Related Art

Pneumatic and electric tools capable of producing an impact force are divided into two types, namely, the direct impact type and the hydraulic pulse type. Hydraulic pulse tools commonly use a hydraulic fluid to produce torque, having the advantages of long lifespan, low noise and vibration levels and overlocking prevention. For these advantages, hydraulic pulse tools are popularly used in the industry.

In order to control the torque output of a hydraulic pulse tool, the hydraulic pulse tool can be equipped with a shutoff mechanism. For example, in the oil pressure type impulse torque generator 5 of U.S. Pat. No. 5,080,181, during rotation of the liner 8 to produce a high pressure, the working oil flows from the high pressure chamber H through the passage P1, the relief valve B and the passage P2 into the low pressure chamber L. At this time, if the pressure does not reach the predetermined value, the relief valve B is supported in the close position by a spring. However, when the pressure surpasses the predetermined value and an impact is produced, the pressure in the high pressure chamber will be discharged from the passage P1 to the passage P2, enabling a part of the pressure to push open the relief valve B and a part of the working oil to be introduced into the cylinder 13d via the passages 11b; 13b. At this time, the pressure acts on the piston 16, with the result that the rod 15 is moved, the shutoff valve mechanism 18 is operated and a set pressure is detected.

However, because the aforesaid prior art shutoff valve mechanism 18 is drivable by the pressure of the working oil and the pressure of the working fluid can easily be affected by the locking operation, the pressure may surpass the predetermined value excessively early or become unstable during the operation, resulting in an erroneous shutoff operation and affecting normal use of the tool. Further, the composition of the aforesaid prior art shutoff mechanism is complicated and difficult to assemble, increasing the overall cost of the tool and narrowing the controllable torque application range.

### SUMMARY OF THE INVENTION

The present invention has been accomplished under the circumstances in view. It is the main object of the present invention to provide a hydraulic pulse tool having a shutoff function that prevents error of judgment and achieves a multi-stage torque output control.

To achieve this and other objects of the present invention, a hydraulic pulse tool of the invention comprises a power supply unit, a drive unit electrically connected to the power supply unit, a hydraulic pulse torque generating unit coupled to the drive unit and rotatable by the drive unit to generate a plurality of impacts that are applied to the drive unit, causing the drive unit to produce an electric current change, and a control unit adapted for judging the electric current change and controlling the operation of the drive unit subject to the judgment result. Thus, in addition to the shutoff function, the hydraulic pulse tool can also reduce errors in judgment and achieve multi-stage torque output control.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 illustrates the architecture of a hydraulic pulse tool in accordance with the present invention.

FIG. 2 is a cross-sectional view of the hydraulic pulse torque generating unit of the hydraulic pulse tool in accordance with the present invention.

FIG. 3 is a system block diagram of the hydraulic pulse tool in accordance with the present invention.

### DETAILED DESCRIPTION OF THE INVENTION

At first, the applicant must declare that, in the preferred embodiment and related drawings to be introduced hereinafter, like reference signs denote like component parts. Further, when describing that one element is mounted in another element means that one element is disposed directly on the other element, or indirectly on the other element, i.e., one or many other elements are arranged between the two elements.

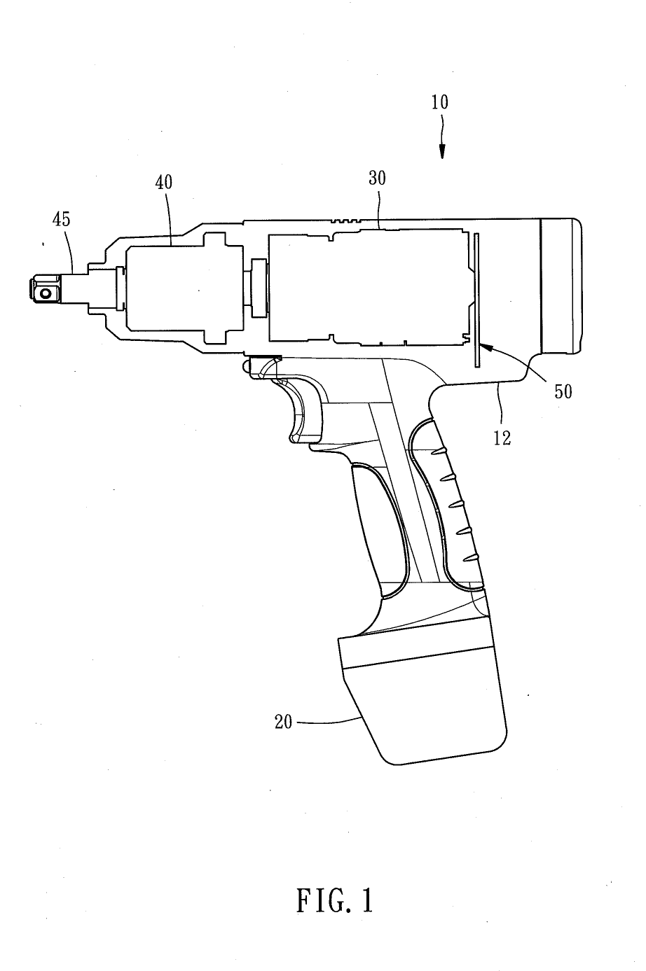

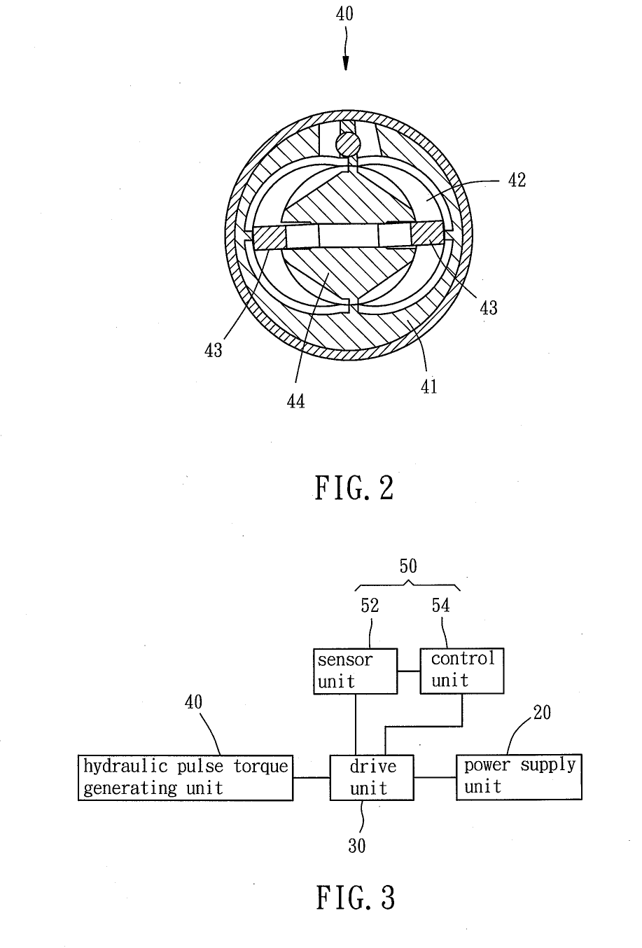

Referring to FIGS. 1-3, a hydraulic pulse tool 10 in the present preferred embodiment is a hand-held power tool. As illustrated, the hydraulic pulse tool 10 comprises a housing 12 holding therein a power supply unit 20, a drive unit 30, a hydraulic pulse torque generating unit 40 and a circuit assembly 50. The power supply unit 20 can be lithium battery or any other alternative battery. The drive unit 30 is electrically connected to the power supply unit 20. In this embodiment, the drive unit 30 is a DC brushless motor. However, other kind of motor can be used as a substitute. The hydraulic pulse tool 10 can be equipped with a switch and electrically connected to the circuit assembly 50 for controlling the operation of the drive unit 30. The hydraulic pulse torque generating unit 40 is coupled to the drive unit 30, enabling the drive unit 30 to rotate a hydraulic cylinder 41 of the hydraulic pulse torque generating unit 40. The hydraulic cylinder 41 is filled up with a hydraulic fluid 42 so that a blade 43 and a driven shaft 44 in the hydraulic cylinder 41 are movable to produce a pressure difference and quantitative pulse and to further generate rotational, causing an output drive 45 to output impulse torque. One impact is produced per one revolution of the hydraulic cylinder 41. The generation of every impact synchronously causes the drive unit 30 to withstand the load and to further produce a current change. For example, when the hydraulic pulse torque generating unit 40 produces one impact, the drive unit 30 will produce one current change corresponding to the load, and thus the hydraulic pulse torque generating unit 40 itself can adjust and set the torque output value.

The circuit assembly 50 comprises a sensor unit 52 and a control unit 54. The sensor unit 52 is electrically connected to the drive unit 30, and adapted to detect the change in the electric current of the drive unit 30. The control unit 54 is adapted to control the operation of the drive unit 30 subject to the change in the electric current detected by the sensor unit 52. The sensor unit 52 in this embodiment can be a current sensing circuit, or any circuit component set capable of obtaining the electric current that passes through the drive unit 30. The control unit 54 can be a microprocessor adapted to control the operating procedure of the drive unit 30 and the procedure of receiving signal from the sensor unit 52. The sensor unit 52 senses each change in the electric current of the drive unit 30 produced subject to each impact generated by the hydraulic pulse torque generating unit 40, and then provides a respective signal to the control unit 54. Thus, the control unit 54 can control the drive unit 30 to operate or not to operate subject to the number of times of the change in the electric current of the drive unit 30, i.e., the number of impacts generated by the hydraulic pulse torque generating unit 40.

During application of the hydraulic pulse tool 10 to, for example, fasten up a screw bolt through the output drive 45, the internal pressure in the hydraulic pulse torque generating unit 40 will be increased as the torque applied to the screw bolt reaches a predetermined value, causing generation of a series of impacts. When the number of impacts surpasses the value set in the control unit 54, the control unit 54 immediately stops the drive unit 30, achieving the effect of shutoff.

Further, the control unit 54 can be set to selectively receive different numbers of impacts, and a setter can be provided for allowing the user to regulate the control unit 54, enabling the control unit 54 to control the torque output of the output drive 45 in a multi-stage control manner, and thus, the hydraulic pulse tool 10 can be flexibly operated to fit different machining procedures.

In conclusion, the invention directly utilizes the impact generation status of the hydraulic pulse torque generating unit 40 to detect the status of the electric current of the drive unit 30 that changes subject to the load, enabling the control unit 54 to determine whether or not to initiate the shutoff function. Thus, the control unit 54 will not initiate the shutoff function too early or too late. The shutoff judgment method of the present invention is accurate and reliable. Further, in the above-described embodiment, the control unit 54 uses the number of impacts for judgment. However, other factors, such as the operating time of the hydraulic pulse torque generating unit, number of revolutions, etc. that are capable of causing the drive unit 30 to produce an electric current change can be used for shutoff function initiation judgment. With the multi-stage shutoff setting, the user can control the torque output of the hydraulic pulse tool.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A hydraulic pulse tool, comprising:
a power supply unit;
a drive unit electrically connected to said power supply unit;
a hydraulic pulse torque generating unit coupled to said drive unit and rotatable by said drive unit to generate a plurality of impacts, said impacts being applied to said drive unit, causing said drive unit to produce an electric current change; and
a control unit adapted for judging said electric current change and controlling the operation of said drive unit subject to the judgment result.

2. The hydraulic pulse tool as claimed in claim 1, further comprising a circuit assembly electrically connected to said drive unit, said circuit assembly comprising said control unit and a sensor unit, said sensor unit being electrically connected to said drive unit and adapted for sensing said electric current change of said drive unit and providing a corresponding signal to said control unit.

3. The hydraulic pulse tool as claimed in claim 1, further comprising a setter electrically connected to said control unit for allowing a user to directly adjust the setting of said control unit.

4. A shutoff control method used in the hydraulic pulse tool as claimed in claim 1, comprising the steps of:
a. setting said control unit;
b. driving said drive unit to rotate said hydraulic pulse torque generating unit, causing said hydraulic pulse torque generating unit to generate an impact status;
c. detecting the impact status generated by said hydraulic pulse torque generating unit; and
d. enabling said control unit to judge said impact status to be in conformity with a predetermined set value or not, and then to stop the operation of said drive unit when said impact status matches with said predetermined set value.

5. The shutoff control method as claimed in claim 4, wherein said impact status is the number of impacts generated by hydraulic pulse torque generating unit.
